(19) United States
(12) Patent Application Publication
(10) Pub. No.: US 2016/0217754 A1
(43) Pub. Date: Jul. 28, 2016

(54) DISPLAY DEVICE AND DRIVING METHOD THEREOF

(71) Applicant: Samsung Display Co., Ltd., Yongin-Si (KR)

(72) Inventors: YU-HAN BAE, Asan-Si (KR); Hyeok-Tae Kwon, Yongin-Si (KR)

(21) Appl. No.: 14/969,088

(22) Filed: Dec. 15, 2015

(30) Foreign Application Priority Data
Jan. 26, 2015 (KR) 10-2015-0012295

(51) Int. Cl. G09G 3/36

(52) U.S. Cl. CPC G09G 3/3607; G09G 3/3614; G09G 3/3688; G09G 2300/0452; G09G 2310/08; G09G 2310/0213; G09G 2310/0218; G09G 2330/021

(57) ABSTRACT

A display device includes gate lines extending in a first direction, data lines extending in a second direction intersection the first direction, first type pixel rows, and second type pixel rows. Each of the first type pixel rows includes a plurality of adjacent first type pixels extending in the first direction. Each of the second type pixel rows includes a plurality of adjacent second type pixels extending in the second direction. Each first type pixel is connected to a j-th data line, and each second type pixel is connected to an (i+1)-th data line, wherein i and j are natural numbers, and each of the first and second type pixels is disposed between two consecutive data lines. The display device of the present disclosure may drive the first type pixel rows during a first sub-frame period, and drive the second type pixel rows during a second sub-frame period.

### CROSS-REFERENCE TO RELATED APPLICATIONS

This U.S. non-provisional patent application claims priority under 35 U.S.C. §119 from Korean Patent Application No. 10-2015-0012295, filed on Jan. 26, 2015, and all the benefits accruing therefrom, the contents of which are herein incorporated by reference in their entirety.

### BACKGROUND

Embodiments of the present disclosure are directed to a display device and a driving method thereof, and more particularly, to a liquid crystal display device and a driving method thereof.

Liquid crystal display devices display images in such a way that transmittance of incident light is controlled by applying electric fields to a liquid crystal layer disposed between two substrates to change the alignment state of liquid crystal molecules.

Driving methods of a liquid crystal device include a line inversion method, a column inversion method, a dot inversion method, etc., according to the phase of data voltages applied to data lines. In a line inversion method, image data is applied to data lines so that the phase of the image data is inverted for every pixel row. In a column inversion method, image data is applied to data lines so that the phase of the image data is inverted for every pixel column. In a dot inversion method, image data is applied to data lines so that the phase of the image data is inverted for every pixel row and every pixel column.

Recently, as structures for connecting pixels of a liquid crystal display device have been studied, an inversion driving method has been optimized for a liquid crystal display device having a specific structure for connecting pixels.

### SUMMARY

Embodiments of the present disclosure can provide a display device and a driving method thereof, the display device being capable of reducing the output frequency of a data driver and thus reducing power consumption.

Embodiments of the inventive concept provide a display device, including a plurality of gate lines, a plurality of data lines, a plurality of first type pixel rows, and a plurality of second type pixel rows.

The gate lines may extend in a first direction. The data lines may extend in a second direction intersecting with the first direction.

Each of the first type pixel rows may include a plurality of adjacent first type pixels that extend along the first direction. Each of the second type pixel rows may include a plurality of adjacent second type pixels that extend along the first direction.

At least one second type pixel row may be disposed between two first type pixel rows.

Each of the first type pixels may be connected to a j-th data line, and of the second type pixels may be connected to an (i+1)-th data line, where i and j are natural numbers, and each of the first and second type pixels is disposed between two consecutive data lines.

One frame period may include contiguous first and second sub-frame periods. The first type pixel rows may be driven during the first sub-frame period, and the second type pixel rows may be driven during the second sub-frame period.

In some embodiments, the display device may apply data voltages to data lines connected to the first type pixels during the first sub-frame period, and apply data voltages to data lines connected to the second type pixels during the second sub-frame period.

In other embodiments, the display device may apply gate signals to the gate lines connected to the first type pixels during the first sub-frame period, and apply gate signals to gate lines connected to the second type pixels during the second sub-frame period.

In still other embodiments, first type pixels in each of the first type pixel rows may be connected to one gate line, and second type pixels in each of the second type pixel rows may be connected to another gate line.

In even other embodiments, the first type pixel rows and the second type pixel rows may be alternately disposed along the second direction.

In yet other embodiments, the first type pixels may be connected to odd-numbered gate lines, and the second type pixels may be connected to even-numbered gate lines. Furthermore, the display device may sequentially apply gate signals to the odd-numbered gate lines during the first sub-frame period, and sequentially apply gate signals to the even-numbered gate lines during the second sub-frame period.

In further embodiments, a polarity of data voltages applied to the data lines may be inverted for at least every data line.

In still further embodiments, first type pixels and the second type pixels disposed between two adjacent data lines may display the same color.

In even further embodiments, each of the first type pixel rows and each of the second type pixel rows may include red, green, and blue pixels repeatedly disposed in that order.

In yet further embodiments, each of the first sub-frame period and the second sub-frame period occupies one half of the frame period.

In other embodiments, gate signals may be non-sequentially applied to the gate lines.

In still other embodiments, the display may further include a gate driver for providing the gate lines with gate signals.

In even other embodiments, the gate driver may include a first gate driver connected to the first type pixels, and a second gate driver connected to the second type pixels.

In yet other embodiments, the first gate driver may receive a first gate control signal, and provide gate lines connected to the first type pixels with gate signals formed based on the first gate control signal.

In further embodiments, the second gate driver may receive a second gate control signal different from the first gate control signal, and provide gate lines connected to the second type pixels with gate signals formed based on the second gate control signal.

Other embodiments of the inventive concept provide a method of driving a display device, the driving method including: driving a plurality of first type pixel rows during a first sub-frame period which is a first portion of one frame period; and driving a plurality of second type pixel rows during a second sub-frame period which is a second portion of the one frame period, wherein the display panel may include a plurality of gate lines extending in a first direction, a plurality of data lines extending in a second direction intersecting with the first direction, each of the plurality of first type pixel rows includes a plurality of adjacent first type pixels extending in the first direction, and each of the plurality of second type pixel rows includes a plurality of adjacent second type pixels extending in the first direction, wherein each of the first type pixels is connected to a j-th data line, each of the second type pixels is connected to a (i+1)-th data line, wherein i and j are natural numbers, and each of the first and second type pixels is disposed between two consecutive data lines.

In some embodiments, at least one second type pixel row may be disposed between two first type pixel rows.

In other embodiments, driving the first type pixel rows may include applying data voltages and gate signals to data lines and gate lines connected to the first type pixels during the first sub-frame period, respectively.

In still other embodiments, driving the second type pixel rows may include applying data voltages and gate signals to data lines and gate lines connected to the second type pixels during the second sub-frame period, respectively.

In even other embodiments, the first type pixel rows and the second type pixel rows may be alternately disposed along the second direction, the first type pixels may be connected to odd-numbered gate lines of the gate lines, and the second type pixels may be connected to even-numbered gate lines of the gate lines. Furthermore, driving the first type pixel rows may include sequentially applying gate signals to the odd-numbered gate lines during the first sub-frame period, and sequentially applying gate signals to the even-numbered gate lines during the second sub-frame period.

Other embodiments of the inventive concept provide a display device that includes a plurality of gate lines, a plurality of data lines, a plurality of first type pixel rows, and a plurality of second type pixel rows. The gate lines may extend in a first direction, and the data lines may extend in a second direction intersecting with the first direction. Each first type pixel row may include a plurality of adjacent first type pixels extending in the first direction, and each second type pixel rows may be alternately disposed with the first type pixel rows along the second direction, and may include a plurality of adjacent second type pixels extending in the first direction. Each of the first type pixels is connected to a k-th data line, and each of the second type pixels is connected to a (k+1)-th data line, wherein k is a natural number.

Gate signals may be sequentially applied to the odd-numbered gate lines during a first sub-frame period of a frame; and gate signals may be sequentially applied to the even-numbered gate lines during a second sub-frame period of the frame.

### BRIEF DESCRIPTION OF THE DRAWINGS

FIG. 1 is a schematic block diagram of a liquid crystal display device according to an embodiment of the inventive concept.

FIG. 2 is an equivalent circuit diagram of one pixel in FIG. 1.

FIG. 3 is a plan view of a display panel according to an embodiment of the inventive concept.

FIG. 4 illustrates data voltages applied to data lines and gate signals applied to gate lines to display the pattern in FIG. 3.

FIG. 5 is a block diagram of a display panel and gate drivers according to an embodiment of the inventive concept.

FIG. 6 is a timing diagram of signals input and output from/to the first and second gate drivers in FIG. 5.

### DETAILED DESCRIPTION OF EXEMPLARY EMBODIMENTS

Embodiments of the present disclosure may be variously modified and embodied in various forms, and thus the inventive concept will be described in detail with reference to particular embodiments illustrated in the drawings. However, the particular embodiments disclosed herein are not intended to limit the inventive concept, but the inventive concept and all modifications, equivalents or substitutes within the inventive concept will be construed to be included in the scope of the present disclosure.

Hereinafter, embodiments of the inventive concept will be described in detail with reference to the accompanying drawings.

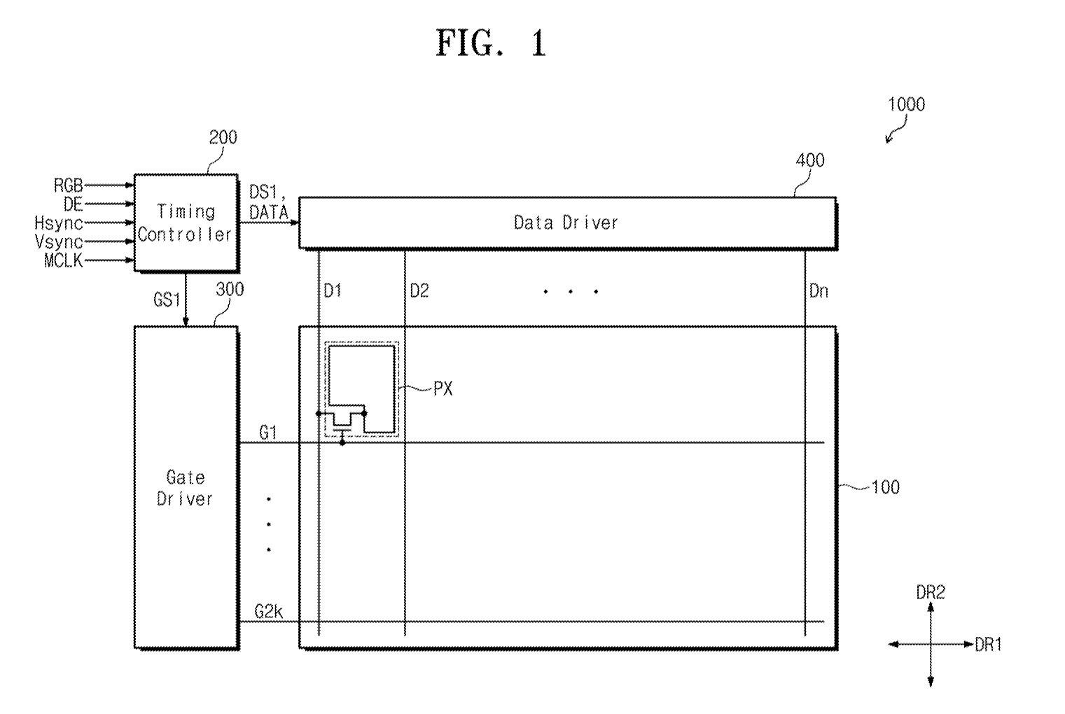

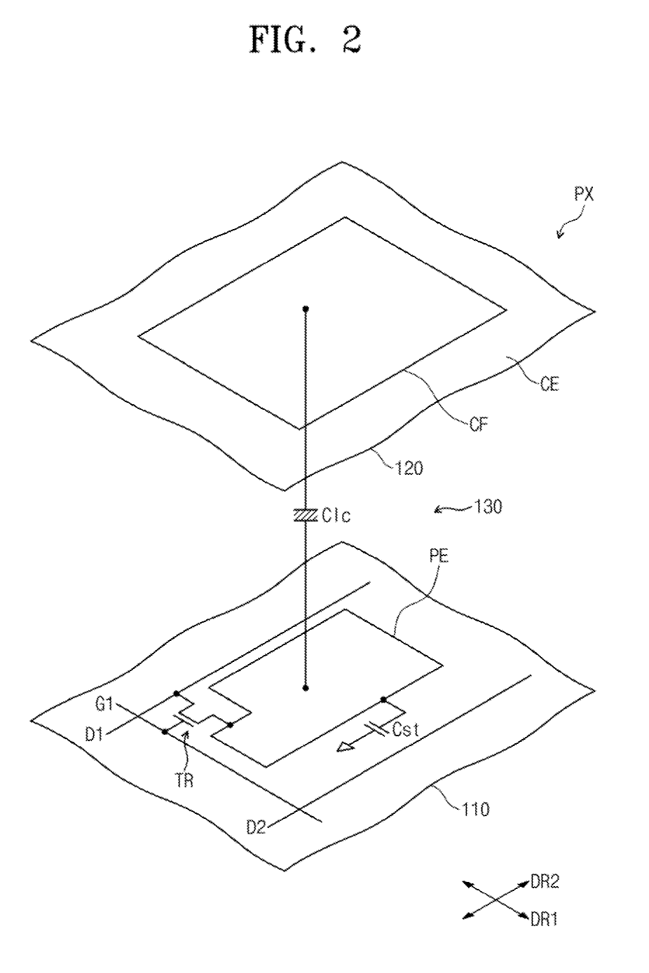

FIG. 1 is a schematic block diagram of a liquid crystal display device according to an embodiment of the inventive concept. FIG. 2 is an equivalent circuit diagram of one pixel in FIG. 1.

As illustrated in FIG. 1, a display device 1000 according to an embodiment of the inventive concept includes a display panel 100, a timing controller 200, a gate driver 300, and a data driver 400.

The display panel 100 may include a lower substrate 110, an upper substrate 120 facing the lower substrate 110, and a liquid crystal layer 130 disposed between the two substrates 110 and 120.

The display panel 100 includes a plurality of gate lines G1 to G2k extending in a first direction DR1, and a plurality of data lines D1 to Dn extending in a second direction DR2 intersecting with the first direction DR1. The gate lines G1 to G2k and the data lines D1 to Dn define pixel regions, and each pixel region includes a pixel PX that displays an image. In FIG. 2, a pixel PX connected to the first gate line G1 and the first data line D1 is illustrated as an example.

The pixel PX may include a thin film transistor TR connected to the gate lines G1 to G2k, a liquid crystal capacitor Clc connected to the thin film transistor TR, and a storage capacitor Cst connected in parallel with the liquid crystal capacitor Clc. The storage capacitor Cst may be omitted, if necessary. The thin film transistor TR may be disposed on the lower substrate 110. A gate electrode of the thin film transistor TR may be connected to the first gate line G1, a source electrode thereof may be connected to the first data line D1, a drain electrode thereof may be connected to the liquid crystal capacitor Clc and the storage capacitor Cst.

The liquid crystal capacitor Clc includes two terminals, i.e., a pixel electrode PE disposed on the lower substrate 110 and a common electrode CE disposed on the upper substrate 120, and the liquid crystal layer 130 disposed between the two electrodes PE and CE functions as a dielectric. The pixel electrode PE is connected to the thin film transistor TR via the drain electrode, and the common electrode CE is formed entirely on the upper substrate 120 and receives a common voltage. Alternatively to the case shown in FIG. 2, the common electrode CE may be disposed on the lower substrate 110, and in this case, at least one of the two electrodes PE and CE may include a slit.

The storage capacitor Cst plays an auxiliary role to the liquid crystal capacitor Clc, and may include the pixel electrode PE, a storage line, and an insulator disposed between the pixel electrode PE and the storage line. The storage line may be disposed on the lower substrate 110, and may overlap a portion of the pixel electrode PE. A constant voltage such as a storage voltage is applied to the storage line.

The pixel PX may display one of the primary colors. The primary colors may include red, green, blue, and white. Alternatively, the colors displayed by the pixel are not limited thereto, but may further include a variety of secondary colors such as yellow, cyan, and magenta. The pixels PX may further include a color filter CF for displaying one of the primary colors. In FIG. 2, an exemplary color filter CF is illustrated as being disposed on the upper substrate 120. However, embodiments of the inventive concept are not limited thereto, and the color filter CF may be disposed on the lower substrate 110.

The timing controller 200 receives image data RGB and control signals from an external graphic controller. The control signals may include a vertical synchronizing signal Vsync for distinguishing frames, a horizontal synchronizing signal Hsync for distinguishing rows, a data enable signal DE having a high level only during data output periods to indicate data input areas, and a main clock signal MCLK.

The timing controller 200 converts the image data RGB to meet specifications of the data driver 400, and outputs the converted image data DATA to the data driver 400. The timing controller 200 generates a gate control signal GS1 and a data control signal DS1. The timing controller 200 outputs the gate control signal GS1 and the data control signal DS1 to the gate driver 300 and the data driver 400, respectively.

The timing controller 200 may include a memory in which the image data RGB may be stored on a frame-by-frame basis.

The gate control signal GS1 is configured for driving the gate driver 300, and the data control signal DS1 is configured for driving the data driver 400.

The gate driver 300 generates gate signals based on the gate control signal

GS1, and outputs the gate signals to the gate lines G1 to G2k. The gate control signal GS1 may include a scanning start signal which indicates the start of scanning, at least one gate clock signal which controls the output period of a gate-on voltage, and an output enable signal which defines the time duration of the gate-on voltage.

The data driver 400 generates gray scale voltages according to the image data DATA based on the data control signal DS1, and outputs the generated gray scale voltages to the data lines D1 to Dn as data voltages. The data voltages may include positive data voltages having positive values and negative data voltages having negative values with respect to the common voltage. The data control signal DS 1 may include a horizontal start signal which indicates the start of transmission of the image data DATA to the data driver 400, a load signal indicating application of data voltages to the data lines D1 to Dn, and an inversion signal which inverts polarity of the data voltages with respect to the common voltage.

Polarity of a data voltage applied to the pixel PX may be inverted between the end of one frame and the beginning of the next frame to prevent degradation of the liquid crystal. That is, polarity of a data voltage may be inverted on a frame-by-frame basis in response to the inversion signal applied to the data driver 400. When one frame of an image is displayed, the display panel 100 may be driven in such a way that data voltages having different polarities are applied to at least one data line to improve image quality.

The timing controller 200, the gate driver 300, and the data driver 400 may each be directly mounted on the display panel 100 in the form of at least one integrated circuit chip, may be mounted on a flexible printed circuit board and then attached to the display panel 100 in the form of a tape carrier package, or may be mounted on a separate printed circuit board. Alternatively, at least one of the gate driver 300 and the data driver 400 may be integrated with the display panel 100 together with the gate lines G1 to G2k, the data lines D1 to Dn, and the thin film transistor TR. Furthermore, the timing controller 200, the gate driver 300, and the data driver 400 may be integrated as a single chip.

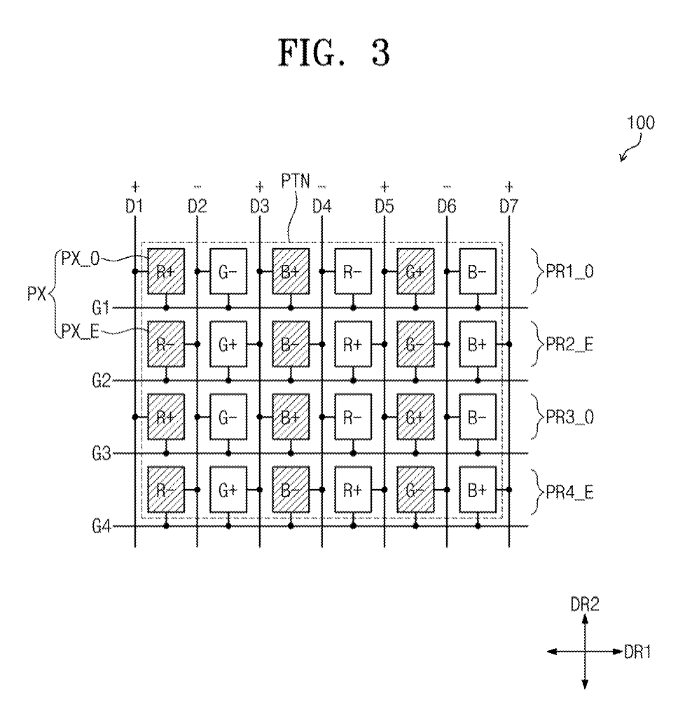

FIG. 3 is a plan view of a display panel according to an embodiment of the inventive concept. FIG. 3 depicts the display panel 100 as including first to fourth gate lines G1 to G4, first to seventh data lines D1 to D7, and pixels.

The display panel 100 may include first type pixel rows PR1_O and PR3_O, and second type pixel rows PR2_E and PR4_E. The pixels PX may include a first type pixel PX_O and a second type pixel PX_E.

Each of the first type pixel rows PR1_O and PR3_O includes first type pixels PX_O adjacent to each other along the first direction DR1. FIG. 3 depicts the first type pixel rows PR1_O and PR3_O as including a first pixel row PR1_O and a third pixel row PR3_O.

Each of the first type pixels PX_O may be connected to a j-th data line, where j is a natural number, with each of the first type pixels PX_O disposed between parallel j-th and (j+1)-th data lines. FIG. 3 depicts that each of the first type pixels PX_O are connected to a data line disposed at the left side of each of the first type pixels PX_O. For example, a pixel R+ of pixels included in the first pixel row PR1_O is disposed between first and second data lines D1 and D2, and may be connected to the first data line D1.

The first type pixels PX_O included in each of the first type pixel rows PR1_O and PR3_O may be connected to the same gate line. For example, first type pixels included in the first pixel row PR1_O may all be connected to the first gate line G1.

Each of the second type pixel rows PR2_E and PR4_E includes adjacent second type pixels PX_E along the first direction DR1. FIG. 3 depicts the second type pixel rows PR2_E and PR4_E as including a second pixel row PR2_E and a fourth pixel row PR4_E.

Each of the second type pixels PX_E may be connected to an (i+1)-th data line, where i is a natural number, with each of the second type pixels PX_E disposed between parallel i-th and (i+1)-th data lines. FIG. 3depicts that each of the second type pixels PX_E are connected to a data line disposed at the right side of each of the second type pixels PX_E. For example, a pixel R− of the pixels included in the second pixel row PR2_E is disposed between the first and second data lines D1 and D2, and may be connected to the second data line D2.

The second type pixels PX_E included in each of the second type pixel rows PR2_E and PR4_E may be connected to the same gate line. For example, second type pixels included in the second pixel row PR2_E may all be connected to a second gate line G2.

At least one second type pixel row may be disposed between two first type pixel rows. In other words, the first type pixel rows PR1_O and PR3_O and the second type pixel rows PR2_E and PR4_E may be alternately disposed along the second direction DR2. FIG. 3 depicts that the first type pixel rows PR1_O and PR3_O and the second type pixel rows PR2_E and PR4_E are alternately disposed along the second direction DR2. That is, the second pixel row PR2_E may be disposed between the first pixel row PR1_O and the third pixel row PR3_O. Furthermore, according to embodiments of the disclosure, each column of alternating first type pixels and second type pixels may be disposed between consecutive data lines, and each data line may disposed between two consecutive columns of alternating first type pixels and second type pixels, where each first type pixel is connected to a k-th data line, and each second type pixel is connected to a (k+1)th data line, where k is a natural number.

Data voltages to be applied to the pixels PX may be provided to the first to seventh data lines D1 to D7. The polarities of the data voltages provided to the first to seventh data lines D1 to D7 may be inverted at least every data line. For example, the data voltages applied to the first to seventh data lines D1 to D7 may be inverted at every data line. FIG. 3 depicts that, starting from the first data line D1, a positive data voltage and a negative voltage are alternately applied.

The pixels PX may include red, green, and blue pixels. In FIG. 3, red, green, and blue pixels are denoted as R, G, and B, respectively. Also, pixels that receive positive data voltages are denoted as R+, G+, and B+, and pixels that receive negative data voltages are denoted as R−, G−, and B−.

In each of the first to fourth pixel rows PR1_O, PR2_E, PR3_O, and PR4_E, the red, green, and blue pixels R, G, and B may be repetitively disposed in that order. However, embodiments of the inventive concept are not limited thereto, and the pixels PX may further include a white pixel in addition to the red, green, and blue pixels R, G, and B.

According to an embodiment of the inventive concept, pixels disposed between two adjacent data lines of the first to seventh data lines D1 to D7 may display the same color. For example, pixels disposed between the first and second data lines D1 and D2 may all be red pixels R.

FIG. 3 illustrates a pattern PTN displayed in the display panel 100. FIG. 3 depicts maximum gray-scale levels as being displayed in hatched pixels, and minimum gray-scale levels or black as being displayed in non-hatched pixels. The pattern PTN in FIG. 3 corresponds to an exemplary image that can allow the display device 1000 according to an embodiment of the inventive concept to achieve maximum efficiency. However, patterns other than the pattern in FIG. 3 may also achieve maximum efficiency for the display device 1000 according to an embodiment of the inventive concept.

Referring to FIG. 3, the pattern PTN displayed in the display panel 100 is displayed by pixels adjacent to each other along the second direction DR2 and displayed in alternate columns along the first direction DR1. A maximum level data voltage corresponding to a maximum gray-scale level may be applied to pixels between the first and second data lines D1 and D2, to pixels between the third and fourth data lines D3 and D4, and to pixels between the fifth and sixth data lines D5 and D6. A minimum level data voltage corresponding to a minimum gray-scale level may be applied to pixels between the second and third data lines D2 and D3, to pixels between the fourth and fifth data lines D4 and D5, and to pixels the sixth and seventh data lines D6 and D7.

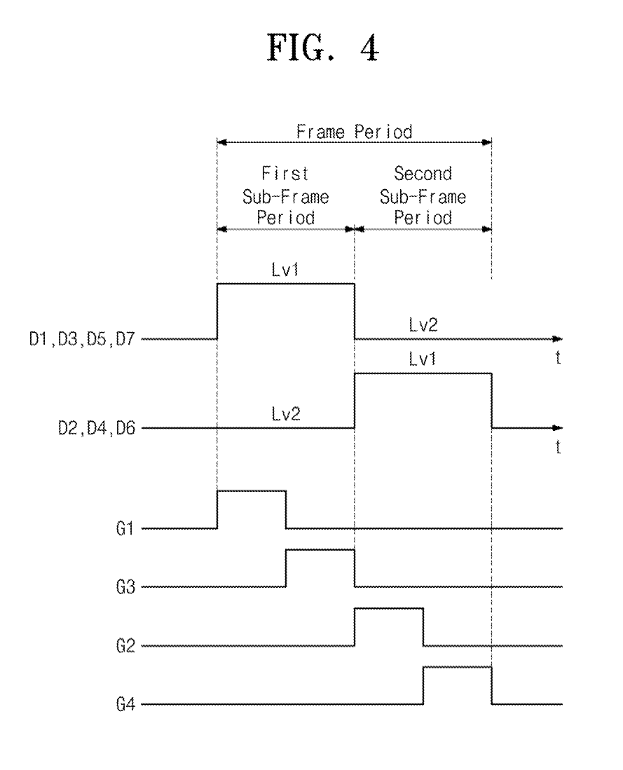

FIG. 4 illustrates data voltages applied to data lines and gate signals applied to gate lines to display the pattern in FIG. 3.

Referring to FIGS. 3 and 4, to display the pattern PTN, during one frame period, data voltages may be applied to the first to seventh data lines D1 to D7 and gate signals may be applied to the first to fourth gate lines G1 to G4.

The frame period may include a first sub-frame period and a second sub-frame period in that order. Each sub-frame period may occupy one half of the frame period.

The first type pixel rows PR1_O and PR3_O may be driven during the first sub-frame period, and the second type pixel rows PR2_E and PR4_E may be driven during the second sub-frame period.

Gate signals may be non-sequentially applied to the first to fourth gate lines G1 to G4. As an example, gate signals may be applied to the first, third, second, and fourth gate lines G1, G3, G2, and G4 in that order.

During the first sub-frame period, a first level data voltage Lv1 corresponding to a maximum gray-scale level may be applied to the first, third, fifth, and seventh data lines D1, D3, D5, and D7. Of the data voltages applied during the first sub-frame period, data voltages applied during an ON-period of a gate signal applied to the first gate line G1 are applied to first type pixels in the first pixel row PR1_O. Of the data voltages applied during the first sub-frame period, data voltages applied during an ON-period of a gate signal applied to the third gate line G3 are applied to first type pixels included in the third pixel row PR3_O.

During the second sub-frame period, a second level data voltage Lv2 corresponding to a minimum gray-scale level may be applied to the first, third, fifth, and seventh data lines D1, D3, D5, and D7.

During the second sub-frame period, a first level data voltage Lv1 corresponding to a maximum gray-scale level may be applied to the second, fourth, and sixth data lines D2, D4, and D6. Of the data voltages applied during the second sub-frame period, data voltages applied during an ON-period of a gate signal applied to the second gate line G2 are applied to second type pixels in the second pixel row PR2_E. Of the data voltages applied during the second sub-frame period, data voltages applied during an ON-period of a gate signal applied to the fourth gate line G4 are applied to second type pixels in the fourth pixel row PR4_E.

During the first sub-frame period, a second level data voltage Lv2 corresponding to a minimum gray-scale level may be applied to the second, fourth, and sixth data lines D2, D4, and D6.

Since the first to fourth pixel rows PR1_O, PR2_E, PR3_O, and PR4_E do not sequentially display images, a memory for storing data corresponding to one frame may be required. The memory may be provided within the timing controller 200, shown in FIG. 1.

When the display panel 100 displays the pattern PTN, if the first to fourth pixel rows PR1_O, PR2_E, PR3_O, and PR4_E are sequentially driven, data voltages applied to the first to seventh data lines D1 to D7 will swing between the first and second levels Lv1 and Lv2 for each time a pixel row is driven. This may cause an increase in the output frequency of the data driver 400, shown in FIG. 1, which provides the first to seventh data lines D1 to D7 with data voltages, which may increase power consumption.

The display device 1000 according to an embodiment of the inventive concept can, within one frame period, drive the first type pixel rows PR1_O and PR3_O, and then drive the second type pixel rows PR2_E and PR4_E, which can reduce the frequency of data voltages applied to the first to seventh data lines D1 to D7. Therefore, the output frequency of a data driver may be reduced, and power consumption may thus be reduced.

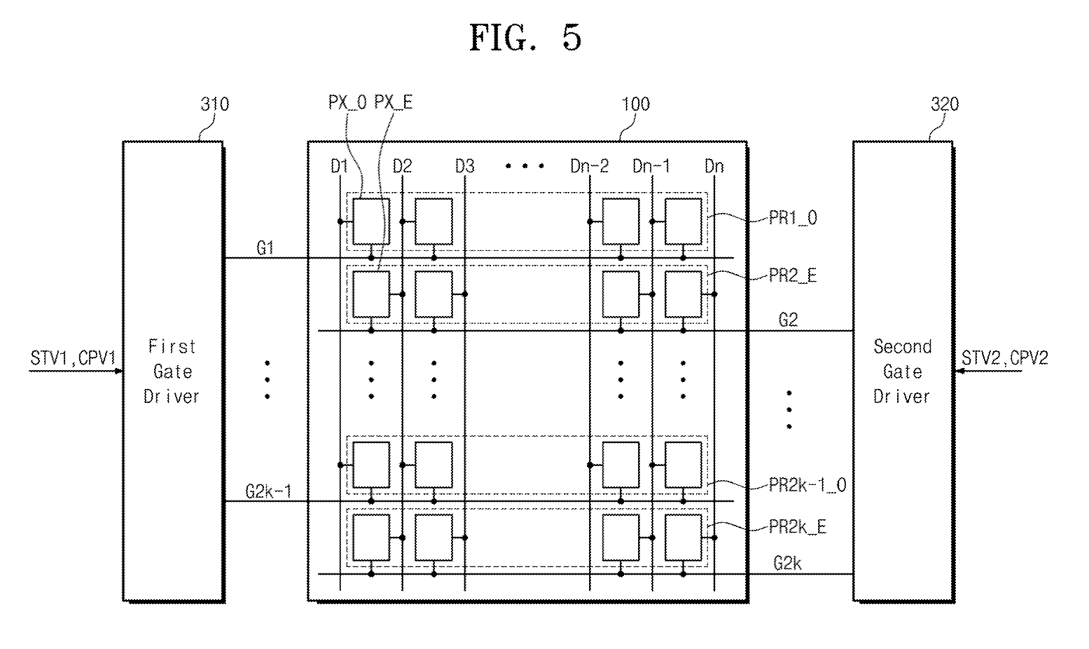

FIG. 5 is a block diagram of a display panel and gate drivers according to an embodiment of the inventive concept.

Referring to FIGS. 1 to 5, the display panel 100 may include first to 2k-th gate lines G1 to G2k, first to n-th data lines D1 to Dn, first type pixel rows PRO to PR2k−1_O, and second type pixel rows PR2_E to PR2k_E.

For example, FIG. 5 shows that first type pixels PX_O in the first type pixel rows PR1_O to PR2k−1_O are connected to odd-numbered gate lines G1 to G2k−1, and second type pixels PX_E in the second type pixel rows PR2_E to PR2k_E are connected to even-numbered gate lines G2 to G2k.

The display panel 100 was described with reference to FIG. 3, and a repeated description thereof will thus be omitted for brevity.

The gate driver 300 includes first and second gate drivers 310 and 320.

The first gate driver 310 is connected to the first type pixels PX_O of the first type pixel rows PR1_O to PR2k−1_O. Specifically, the first gate driver 310 may be connected to the odd numbered gate lines G1 to G2k−1.

The second gate driver 320 is connected to the second type pixels PX_E of the second type pixel rows PR2_E to PR2k_E. Specifically, the second gate driver 320 may be connected to the even-numbered gate lines G2 to G2k.

The gate control signal GS1 may include a first gate control signal provided to the first gate driver 310 and a second gate control signal provided to the second gate driver 320.

The first gate control signal may include a first scanning start signal STV1 which indicates when to start scanning the odd-numbered gate lines G1 to G2k−1, a first gate clock signal CPV1 which controls the output period of gate signals applied to the odd-numbered gate lines G1 to G2k−1, hereinafter the odd-numbered gate signals, and a first output enable signal which controls the pulse width of odd-numbered gate signals.

The second gate control signal may include a second scanning start signal STV2 which indicates when to start scanning the even-numbered gate lines G2 to G2k, a second gate clock signal CPV2 which controls the output period of gate signals applied to the even-numbered gate lines G2 to G2k, hereinafter the even-numbered gate signals, and a second output enable signal which controls the pulse width of even-numbered gate signals.

The first gate driver 310 may form gate signals based on the first gate control signal, and transmit the odd-numbered gate signals. The second gate driver 320 may form gate signals based on the second gate control signal, and transmit the even-numbered gate signals.

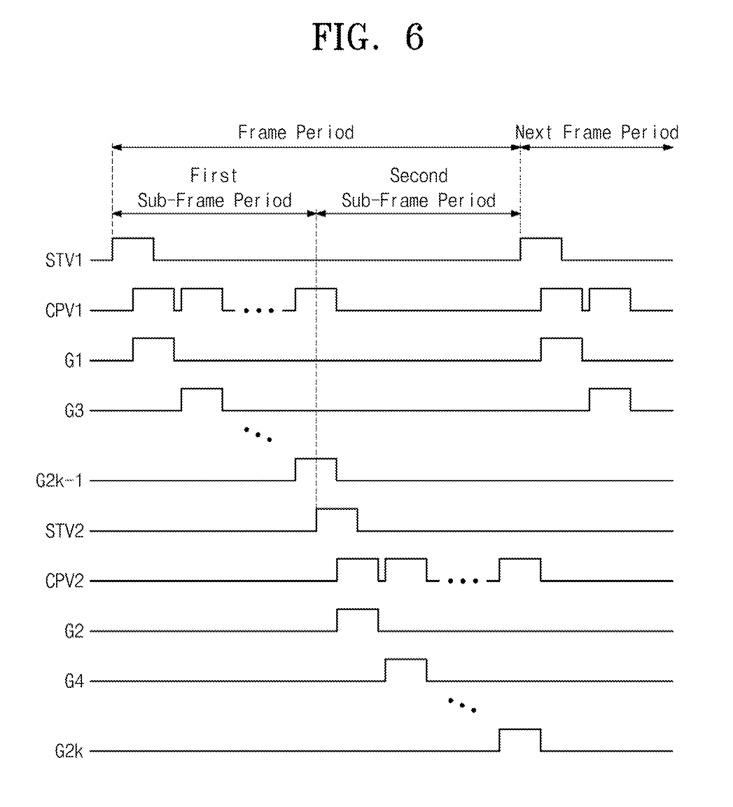

FIG. 6 is a timing diagram of signals input and output from/to the first and second gate drivers in FIG. 5.

Referring to FIGS. 5 and 6, gate signals are provided to the gate lines G1 to G2k during one frame period. The frame period may be divided into a first sub-frame period and a second sub-frame period. The first sub-frame period may be the first half of the frame period, and the second sub-frame period may be the second half of the frame period.

The first gate driver 310 may provide the first type pixels PX_O in the first type pixel rows PR1_O to PR2k−1_O with gate signals during the first sub-frame period. That is, the first gate driver 310 may transmit the odd-numbered gate signals during the first sub-frame period.

When the first scanning start signal STV1 is applied to the first gate driver 310, the first gate driver 310 may sequentially provide the odd-numbered gate lines G1 to G2k−1 with gate signals synchronized with a PULSE-ON period of the first gate clock signal CPV1.

The second gate driver 320 may provide the second type pixels PX_E in the second type pixel rows PR2_E to PR2k_E with gate signals during the second sub-frame period. That is, the second gate driver 320 may transmit the even-numbered gate signals during the second sub-frame period.

When the second scanning start signal STV2 is applied to the second gate driver 320, the second gate driver 320 may sequentially provide the even-numbered gate lines G2 to G2k with gate signals synchronized with a PULSE-ON period of the second gate clock signal CPV2.

The display panel 100 sequentially displays images in the first type pixel rows PR1_O to PR2k−1_O during the first sub-frame period, and sequentially displays images in the second type pixel rows PR2_E to PR2k_E during the second frame period. Therefore, according to a display device and a driving method thereof, a output frequency of a data driver may be reduced, and thus power consumption may be reduced.

Although exemplary embodiments of the present disclosure have been disclosed for illustrative purposes, those skilled in the art will appreciate that various modifications, additions and substitutions are possible, without departing from the scope and spirit of embodiments of the disclosure as disclosed in the accompanying claims.

Accordingly, such modifications, additions and substitutions should also be understood to fall within the scope of embodiments of the present disclosure.

What is claimed is:

1. A display device, comprising:
a plurality of gate lines that extend in a first direction;
a plurality of data lines that extend in a second direction intersecting with the first direction;
a plurality of first type pixel rows, each of which includes a plurality of adjacent first type pixels that extend in the first direction; and
a plurality of second type pixel rows, each of which includes a plurality of adjacent second type pixels that extend in the first direction,
wherein at least one second type pixel row is disposed between two first type pixel rows,
each of the first type pixels is connected to a j-th data line, and each of the second type pixels is connected to an (i+1)-th data line, wherein i and j are natural numbers, and each of the first and second type pixels is disposed between two consecutive data lines,
one frame period includes contiguous first and second sub-frame periods,
the first type pixel rows are driven during the first sub-frame period, and
the second type pixel rows are driven during the second sub-frame period.

2. The display device of claim 1, wherein data voltages are applied to data lines connected to the first type pixels during the first sub-frame period, and data voltages are applied to data lines connected to the second type pixels during the second sub-frame period.

3. The display device of claim 1, wherein gate signals are applied to gate lines connected to the first type pixels during the first sub-frame period, and gate signals are applied to gate lines connected to the second type pixels during the second sub-frame period.

4. The display device of claim 1, wherein first type pixels in each of the first type pixel rows are connected to one gate line, and second type pixels in each of the second type pixel rows are connected to another gate line.

5. The display device of claim 1, wherein the first type pixel rows and the second type pixel rows are alternately disposed along the second direction.

6. The display device of claim 5, wherein the first type pixels are connected to odd-numbered gate lines, and the second type pixels are connected to even-numbered gate lines; and
gate signals are sequentially applied to the odd-numbered gate lines during the first sub-frame period, and gate signals are sequentially applied to the even-numbered gate lines during the second sub-frame period.

7. The display device of claim 1, wherein a polarity of data voltages applied to the data lines is inverted for at least every data line.

8. The display device of claim 1, wherein first type pixels and second type pixels disposed between two adjacent data lines display the same color.

9. The display device of claim 1, wherein each of the first type pixel rows and each of the second type pixel rows comprise red, green, and blue pixels repeatedly disposed in that order.

10. The display device of claim 1, wherein each of the first sub-frame period and the second sub-frame period occupies one half of the frame period.

11. The display device of claim 1, wherein gate signals are non-sequentially applied to the gate lines.

12. The display device of claim 1, further comprising a gate driver configured to provide the gate lines with gate signals.

13. The display device of claim 12, wherein the gate driver comprises:
a first gate driver connected to the first type pixels; and
a second gate driver connected to the second type pixels.

14. The display device of claim 13, wherein the first gate driver receives a first gate control signal, and provides gate lines connected to the first type pixels with gate signals formed based on the first gate control signal, and
the second gate driver receives a second gate control signal different from the first gate control signal, and provides gate lines connected to the second type pixels with gate signals formed based on the second gate control signal.

15. A method of driving a display device, comprising:
driving a plurality of first type pixel rows of a display panel during a first sub-frame period which is a first portion of one frame period; and
driving a plurality of second type pixel rows of the display panel during a second sub-frame period which is a second portion of the one frame period,
wherein the display panel includes a plurality of gate lines extending in a first direction, a plurality of data lines extending in a second direction intersecting with the first direction, each of the plurality of first type pixel rows includes a plurality of adjacent first type pixels extending in the first direction, and each of the plurality of second type pixel rows includes a plurality of adjacent second type pixels extending in the first direction, wherein each of the first type pixels is connected to a j-th data line, each of the second type pixels is connected to a (i+1)-th data line, wherein i and j are natural numbers, and each of the first and second type pixels is disposed between two consecutive data lines.

16. The driving method of claim 15, wherein at least one second type pixel row is disposed between two first type pixel rows.

17. The driving method of claim 15, wherein driving the first type pixel rows comprises applying data voltages and gate signals to data lines and gate lines connected to the first type pixels during the first sub-frame period, respectively.

18. The driving method of claim 15, wherein driving the second type pixel rows comprises applying data voltages and gate signals to data lines and gate lines connected to the second type pixels during the second sub-frame period, respectively.

19. The driving method of claim 15, wherein the first type pixel rows and the second type pixel rows are alternately disposed along the second direction, the first type pixels are connected to odd-numbered gate lines of the gate lines, the second type pixels are connected to even-numbered gate lines of the gate lines,
driving the first type pixel rows comprises:
sequentially applying gate signals to the odd-numbered gate lines during the first sub-frame period; and
driving the second type pixel rows comprises
sequentially applying gate signals to the even-numbered gate lines during the second sub-frame period.

20. A display device, comprising:
a plurality of gate lines extending in a first direction,
a plurality of data lines extending in a second direction intersecting with the first direction,
a plurality of first type pixel rows, each including a plurality of adjacent first type pixels extending in the first direction, and
a plurality of second type pixel rows alternately disposed with the first type pixel rows along the second direction, each second type pixel row including a plurality of adjacent second type pixels extending in the first direction,
wherein each of the first type pixels is connected to a k-th data line, each of the second type pixels is connected to a (k+1)-th data line, wherein k is a natural number,
wherein gate signals are sequentially applied to the odd-numbered gate lines during a first sub-frame period of a frame; and
gate signals are sequentially applied to the even-numbered gate lines during a second sub-frame period of the frame.
